(19) United States
(12) Patent Application Publication
(10) Pub. No.: US 2026/0125013 A1
(43) Pub. Date: May 7, 2026

(54) CONTROL SYSTEM FOR CONTROLLING A FUNCTION BY MEANS OF A SWITCH

(71) Applicant: AUDI AG, Ingolstadt (DE)

(72) Inventors: Lars ELLERMANN, Ingolstadt (DE); Steffen ROSS, Wettstetten (DE)

(73) Assignee: AUDI AG, Ingolstadt (DE)

(21) Appl. No.: 19/380,077

(22) Filed: Nov. 5, 2025

(30) Foreign Application Priority Data
Nov. 5, 2024 (DE) 10 2024 132 165.2

(51) Int. Cl. B60R 16/037; G06F 3/16; H04R 1/02

(52) U.S. Cl. CPC B60R 16/0373; G06F 3/16; H04R 1/028; H04R 2499/13

(57) ABSTRACT

A control system for controlling at least one function in a motor vehicle. The control system comprises the at least one switch, which generates at least one sensory signal which is assigned to a predetermined state of the switch, the at least one sensory signal being an acoustic signal or an optical signal or a combination of the two signals. The control system moreover comprises at least one detection unit configured to detect the at least one sensory signal of the at least one switch, the at least one detection unit generating a control signal. The control system furthermore comprises a control unit configured to process the control signal generated by the detection unit, the control unit being configured to initiate at least one predetermined function based on the control signal. The detection unit comprises at least two detection elements for recording the at least one sensory signal of the least one switch.

### CROSS REFERENCE TO RELATED APPLICATIONS

This application is a based upon and claims the priority benefit of German Application No. 102024 132 165.2 filed on November 5, 2024, the entire contents of which are incorporated by reference herein.

### BACKGROUND

### 1. Field

The invention relates to a control system for controlling a function by means of a switch, in particular for operating a motor vehicle component, a motor vehicle that comprises such a control system, and a method for controlling a function by means of the control system.

Control systems for controlling a function, in particular for operating a motor vehicle component, are generally known. Such control systems according to the present prior art are, for example, motor vehicle operating systems: switches control, for example, the functions of windows in the motor vehicle, seat heaters, outside mirrors, radio functions, music systems, light controls, or heating controls. Such control systems require the switches, by means of which the respective function is controlled, to close a circuit having at least two wires and thus actuate diverse functions either directly or indirectly via a control device. Such control systems therefore have the disadvantage that the switches always have to be wired and powered.

### 2. Description of the Related Art

DE 102017114990 B3 is directed to providing a display and operating device having a reduced complexity, in particular a reduced number of electrical lines, and for this purpose proposes a display and operating device, in particular a human-machine interface. The operating device comprises a display and a user interface of a vehicle having a turn/push control element, wherein when the turn/push control element is operated, an acoustic signal is generated via a mechanical sound generating element, in particular a metal strip, according to a clicker principle. The signal is detected by a microphone and forwarded as a control signal to set a vehicle function. When the turn/push control element is pressed down, an acoustic signal is generated by a sound generating element and transmitted to the sound pickup. The sound pickup converts the acoustic signal into an electrical output signal, which is then transmitted to the evaluation unit. The evaluation unit recognizes the electrical output signal transmitted by the sound pickup and generates a control signal, for example, for actuating a vehicle component or for navigating through a selection menu.

DE 102022102374 A1 is directed to providing a system for securing a driver assistance system which enables simplified verification of a driver assistance system, in particular a parking aid. For this purpose, DE 102022102374 A1 discloses a system comprising a sensor arrangement configured to detect an operation of an operating element of a vehicle by a user and generate corresponding first detection data, and to detect an acoustic signal, which indicates the operation of the operating element, and generates corresponding second detection data, and at least one evaluation module, which determines a first and a second time based on the detection data.

DE 102013210200 A1 is directed to providing an operating device for a hearing instrument, which manages without additional electrical sensors and without additional electrical connections, is uncomplicated, and operates reliably at the same time. DE 102013210200 A1 discloses for this purpose an operating device for a hearing instrument, such as a hearing aid having a mechanical operating element; when the operating element is operated, an operating noise is detected by a microphone and analyzed as an operating signal.

In particular motor vehicle interiors can produce an astounding variety of noises. The noises can also vary according to the speed of the motor vehicle, in particular in frequency and volume. Noises in the motor vehicle interior can be engine noises, tire noises, wind noises, noises of the climate control system, street noises, noises of the vehicle occupants, noises of electronic devices, noises of motor vehicle interior components or of objects carried in the motor vehicle interior. Such noises are interfering noises which obstruct the detection and identification of the switches proposed in the prior art. The acoustic identification of a specific switch and the correct assignment of the function is also obstructed in that the known clicker principle for generating the acoustic signal can be used in a plurality of switches in a motor vehicle interior. The clicker principle can thus generate similar acoustic signatures and obstruct or make impossible an unambiguous identification of the respective switch.

### SUMMARY

One object of the invention, according to an aspect of the present invention, is to provide a control system, using which an identification of a sensory switch signature improved in comparison to the prior art is possible, wherein the control system can reliably identify a respective switch even if switch noises and/or interference noises are superimposed and can therefore carry out the respective predetermined function reliably. This permits a large number of switches, for example, in a motor vehicle to be able to be operated without wiring and thus enables more sustainable equipment of motor vehicles in comparison to the present prior art.

The objects of the present invention are achieved by the subjects of the independent claims. Advantageous refinements of the invention result from the features of the dependent claims, the following description, and the figures.

An aspect of the invention relates to a control system for controlling at least one function by at least one switch. The function is used in particular for operating a motor vehicle component. The control system comprises at least one switch. In other words, the control system can comprise one or more switches.

The switch generates at least one sensory signal. In other words, the switch generates one or more sensory signals. The sensory signal is assigned to a predetermined state of the switch. One example of the predetermined state is “on” or “off”. The state can also be, for example, a rotational movement of the switch.

The sensory signal is an acoustic signal or an optical signal or a combination of the two signals.

In other words, the switch can generate at least one acoustic signal. The acoustic signal can be audible or inaudible to the human ear. The acoustic signal can be, for example, a sound, a noise, or a tone. The acoustic signal can sound continuously or intermittently, for example, to accompany movement. A suitable example is a click-clack, crack, or latching noise of a switch.

The switch can generate at least one optical signal. The optical signal is a signal in the form of information transmission utilizing the physical properties of light. An optical signal is, for example, a change of the state of the switch which can be detected by means of a light signal. The optical signal can be illustratively explained on the basis of the example of a position change of a rocker switch. The rocker switch is located, for example, in a first state “on” or “off”. In this first state, the rocker switch is in a stable position, the position “on” or “off” is recognizable in a predetermined manner by the orientation of the rocker switch. There is no movement. If the rocker switch is operated, the lever or the rocker moves from the first position, for example, “off”, to the second position “on”. This movement can be visually perceived. The optical signal can change, for example, flashing or a color change can emphasize a movement.

The switch can generate at least one combined acoustic-optical signal. In other words, a combined acoustic-optical signal is a signal which has acoustic and also optical elements. In other words, this is a type of signal which uses both sound and light signals to transmit information. The combination results in a signal which is detectable both acoustically and optically. This is particularly advantageous with high noise levels, since the combination of acoustic and optical signal still permits a reliable identification.

The control system moreover comprises at least one detection unit configured to detect the at least one sensory signal of the at least one switch. The detection unit generates a control signal. In other words, the detection unit generates a control signal based on the detected sensory signal that the switch generates.

The detection unit can furthermore comprise a microcontroller or processor configured to generate the control signal.

The control system furthermore comprises a control unit configured for processing the control signal generated by the detection unit, wherein the control unit is configured to initiate at least one predetermined function based on the control signal. In other words, the control unit is configured to carry out at least one predefined function.

Examples of functions are, in particular in a motor vehicle, light control, for example, switches for operating the low beams, the high beams, or the fog lights, or also the lights in the roof lining present in most vehicles. Further examples in the motor vehicle interior are, for example, switches for operating the window lifters, switches for operating the climate control system, switches for operating the seat adjustment function, wherein this can comprise switches for adjusting the position, the height, the inclination, and/or the lumbar support. Further examples are switches for operating the infotainment system, or also switches for operating the windshield wipers. These switches contribute to the driver being able to operate important functions quickly and intuitively without being greatly distracted from the road traffic in this case.

The control system can comprise a data processing device or a processor unit. The processor unit can comprise for this purpose at least one processor and/or at least one microcontroller and/or at least one FPGA (Field Programmable Gate Array), and/or at least one DSP (Digital Signal Processor). In particular a CPU (Central Processing Unit), a GPU (Graphical Processing Unit), or an NPU (Neural Processing Unit) can each be used as a microprocessor. Furthermore, the processor unit can comprise program code configured, when it is executed by the processor unit, to carry out the embodiment of the method according to the invention. Furthermore, the processor unit can comprise program code configured, when it is executed by the processor unit, to actuate the control system. The program code can be stored in a data memory of the processor unit. The processor unit can be based, for example, on at least one printed circuit board and/or on at least one SoC (System on Chip).

It is provided that the detection unit comprises at least two detection elements for recording the at least one sensory signal of the switch.

A detection unit detects sensory signals, for example, soundwaves, and converts them into electrical signals, in particular into electrical control signals. The detection unit comprises at least two detection elements for this purpose, which detect the at least one sensory signal of the switch. Examples of detection elements are sensors which detect the respective sensory signal. Examples of suitable sensors are in particular acoustic sensors and optical sensors. In other words, the detection unit can comprise at least two sensors which detect the at least one signal of the switch. Examples of suitable further sensors comprise resistive, capacitive, and inductive sensors.

The detection unit can furthermore be configured to amplify and/or filter, for example, the signal detected by the respective detection element in order to prepare the signal for the processing and make it usable. This can comprise, for example, analog or digital signal processing. The detection unit can comprise for this purpose, for example, an analog-to-digital converter.

The advantage results by way of the invention in that an improved identification of a sensory switch signature is possible, wherein the control system can reliably identify a respective switch even if switch noises and/or interference noises are superimposed and can therefore reliably carry out the respective predetermined function. The at least two detection elements in other words permit more accurate localization and assignment of a switch signal, for example, a tone, which is generated upon operation of the switch.

The at least two detection elements have a predetermined distance to one another and to the switch to be detected. The soundwaves of the acoustic signal, for example, reach the two detection elements, such as microphones, at different times, depending on the position of the switch. The time difference between the signals of the two detection elements is measured. The direction of the sound source can be calculated from the time-of-flight difference and the predetermined distance of the detection elements. Moreover, the level difference of the soundwaves can be determined. The direction and distance of the sound source can be identified more precisely than in the prior art from the combination of the time-of-flight and the level differences. For the case that a detection element is an optical detection element, for example, the movement of the switch can be detected. The optical signal is not overlaid with acoustic interference noises and in this way permits a precise identification of the moved switch. The precise identification of the switch on the basis of its acoustic and/or optical switch signature permits more than one switch to be able to be controlled reliably in this way. This therefore permits a large number of switches, for example, in a motor vehicle to be operated without wiring and thus permits more sustained equipment of motor vehicles in comparison to the present prior art.

Electronics costs and the associated installation space are moreover saved due to the omission of the wires and contacts in the switch. Furthermore, there is the potential of producing the switch only from plastic, which enables an improved recycling capability.

The invention also comprises refinements, which result in additional advantages.

One refinement of the invention provides that the switch comprises at least one sound element, in particular a mechanical sound element, for generating the acoustic signal. The advantage results therefrom that a powered switch is not necessary for the sound generation.

The sound element can be constructed, for example, based on the clicker principle. The clicker principle relates to sound generation by using a spring having two states, a stable state and a metastable state. In the stable state, the spring is in its undeformed position. The spring is neither stretched nor compressed and is in an energetically favorable state. If the spring is bent by operating a rocker switch, for example, it jumps from the stable state into the metastable state. The metastable state is less stable and is only maintained by the force acting on the spring. As soon as the force decreases, the spring returns to its stable state. The characteristic clicking noise is generated when the spring jumps from one state to the other. A suitable example is a click-clack, crack, or latching noise of a switch.

One refinement of the invention provides that the at least one sound element comprises a snap over contour. The advantage results therefrom that the sound element locks into a stable position. This prevents undesired movements and ensures precise control of the sound. The sound generated in a structurally simple manner upon snapping over is a clear signal that is acoustically identifiable well. This is particularly advantageous if, for example, a visual check is difficult for reasons of the arrangement of the switch. For example, the switch can be arranged in a motor vehicle interior such that interior cameras cannot record the switch. The wear of the mechanical parts is reduced by the defined movement and the locking, which lengthens the service life of the sound element. This contributes to the sound quality remaining constant in a structurally simple manner over time.

One refinement of the invention provides that the sound element is mounted in a decoupled manner. The advantage results therefrom that interference noises from the surroundings of the switch are damped. Examples of such interference noises are structure-borne sound, and/or panel vibrations, for example, in a motor vehicle. It is conceivable that panel vibrations can inadvertently trigger a sensitively set switch. The sound precision is improved by the decoupling of such interference noises and inadvertent triggering of the switch is reduced or prevented.

One refinement of the invention provides that the switch comprises at least one damping element for decoupling the sound element, wherein the damping element in particular comprises an elastomer or is formed from an elastomer. The advantage results therefrom that vibrations are damped particularly effectively. Elastomers absorb and insulate oscillations, which would otherwise be transmitted to the sound element and thus prevent undesired resonances. The sound quality is improved in this way, the sound becomes clearer and more precise. Elastomers are long-lived and free of maintenance and maintain their damping properties over a long time. The damping element is configured, for example, to interrupt a mechanical coupling of the sound element with other components and therefore reduce oscillations and vibrations. The damping element furthermore permits it to be ensured precisely after a sound, for example, such as a clicking noise, that reverberation, thus an interfering noise, in particular an interfering frequency is not detectable or is at least reduced.

One refinement of the invention provides that the at least two detection elements are acoustic detection elements, in particular microphones. The advantage results in this way that the switch can be reliably identified in a structurally simple manner by means of time-of-flight difference and level difference of the respective acoustic signal in consideration of the predetermined distance.

Alternatively thereto, at least one detection element of the at least two detection elements can be an acoustic detection element, in particular a microphone, and at least one detection element of the two detection elements can be an optical detection element, in particular a camera. The advantage results in this way that even with particularly loud interfering noises, it is reliably possible to identify the switch. In other words, the at least two detection elements can be identical sensor types in this case, thus, for example, two acoustic sensors. Alternatively, an acoustic sensor and an optical sensor can also be provided.

The detection unit can particularly advantageously comprise at least one further detection element, for example, a further acoustic sensor. In particular, three equivalent detection elements, such as three acoustic detection elements, permit particularly accurate localizing of the switch.

One refinement of the invention provides that the detection unit comprises at least one further detection element for detecting sensory signals, in particular at least one capacitive sensor, a pressure sensor, a temperature sensor, and/or an infrared sensor, and/or a light sensor, in particular a light barrier, or an ambient light sensor, and/or an acoustic sensor and/or an optical sensor, in particular an optical proximity sensor, and/or a resistive sensor and/or an inductive sensor. This permits additional information of the switch signature to be used to identify the switch, wherein this information is not overlaid with acoustic interfering noises.

One refinement of the invention provides that the detection unit is additionally configured to apply a functional logic, to apply predefined parameter data, and/or to apply further sensor data to control the at least one function. The advantage results therefrom that, for example, sensors already present in a motor vehicle, additionally stored algorithms, predefined stored data, and/or additional information by way of additional sensor data, such as data from seat heater sensors, door heating elements, or steering wheel sensors enables the identification of the operated switch and the function thus selected to be made more precise.

For example, cameras in combination with AI algorithms can analyze visual data to identify switches even more precisely. Further examples are interpreting speech commands and/or gesture recognition and/or the use of machine learning with the aid of which a switch can be monitored in real time.

One refinement of the invention provides that the switch is a mechanical switch, in particular a rocker switch, or a rotating switch or a turn-press switch or a toggle switch, or a button. Typical switches can advantageously be used, the sound of which is already known to the driver and which does not distract the driver from the road traffic.

One refinement of the invention provides that the switch is a rotating switch or a turn-press switch and the respective rotational direction of the rotating switch is assigned an acoustic and/or optical signal. Such switches generate an acoustic-optical signal in a structurally simple manner.

One particularly advantageous refinement provides that the switch is a rotating switch and that the detection unit comprises at least one acoustic detection element and one optical detection element. The advantage results therefrom that the control signal of the detection unit contains further function information, for example, from the direction of the hand movement and/or the rotational direction, which permits, for example, the initiation of a louder or softer function when setting the volume of the audio system, for example.

One refinement of the invention provides that the predetermined function is a comfort function. The advantage results therefrom that the wiring can be restricted to safety-relevant switches. Fewer wires also result in fewer wiring error sources and also increase the safety of the safety-relevant switches in this way. This also results in simplified maintenance and troubleshooting. The comfort functions can be made structurally simple and even more user-friendly utilizing existing sensors in comparison to wired switches by the control system according to the invention. More sensory information can be incorporated to identify and monitor, for example, the driver behavior in the control and can thus result in an additionally improved user experience.

Additionally or alternatively, the initiation of the predetermined function can initiate a further function. For example, the outside mirrors can be adjusted accordingly in a user-friendly manner in conjunction with the execution of the adjustment of the seat. Optical signals can particularly advantageously also be used for this purpose: The advantage results therefrom that user-friendly control interfaces can be defined, which also additionally facilitate the operation for the user.

One refinement of the invention provides that the detection unit is configured for detecting user data, wherein the detection unit is configured to generate a control signal based on the received user data. The advantage results in this way that the desired function can be inferred from the user data. For example, if an operation is identified in the area of the window lifter and all windows are closed, lowering the window is initiated. It is also conceivable that additional user data are used, for example, in the adjustment of the outside mirrors. For example, in order to additionally adjust the alignment of the mirrors, the eye height of the driver can be determined by means of at least one optical detection element. The detection element can be designed, for example, as a camera, in particular as an interior camera.

Additionally or alternatively thereto, the detection unit can communicate with a neural network. The neural network is trained to process received user data. The neural network can be configured such that the neural network provides data to the detection unit based on the processed user data. The advantage results in this way that overall processing of all available data can take place efficiently and quickly and the system learns from the user behavior.

A second aspect of the invention relates to a motor vehicle, characterized in that the vehicle comprises at least one control system according to the invention. The motor vehicle according to the invention is preferably designed as an automobile, in particular as a passenger vehicle or truck, or as a bus. In other words, the invention comprises a motor vehicle, wherein it can be, for example, a passenger vehicle, a ship, an aircraft, a train, or a transport capsule.

One refinement of the invention provides that at least one switch is assigned to at least one predetermined zone in the interior of the motor vehicle. A zone is in other words an area, for example, in a motor vehicle, to which specific functions are assigned. Zones in the interior of the motor vehicle are, for example, doors, in particular inner panels of doors, seats in the automobile, in particular front seats, the center console, a functional island, the cockpit, or the roof lining. The cockpit comprises the dashboard, the steering wheel, and further operating elements. For example, there are also climate control zones, safety zones, and infotainment zones in a motor vehicle. Climate control zones are, for example, individually controllable zones, in particular driver seat, front passenger seat, and rear seats, in each of which the room temperature can be individually controlled for the respective zone. Infotainment zones are areas in which displays and operating elements for navigation, audio, and other media are provided.

Additionally or alternatively, at least one detection unit can be assigned to at least one predetermined zone in the motor vehicle interior.

Additionally or alternatively, at least one function, in particular of at least one of the predetermined zones, in particular of an operating element of the predetermined zone in the interior of the motor vehicle, can be assigned to the at least one switch.

Acoustic detection elements, in particular microphones, are often arranged in a motor vehicle, for example, in the roof lining, in the rearview mirror, in the dashboard, and/or in the A-pillar.

Optical detection elements, in particular cameras, in particular interior cameras, are often arranged in a motor vehicle, for example, in the rearview mirror, in the dashboard, in the roof lining, and/or in the A-pillar.

Further sensors in a motor vehicle are, for example, seat heaters, which can be used, for example, as a capacitive sensor. For example, the position of a hand of the driver can be established. It can be established, for example, whether the hand is located next to the steering wheel or in the area of the door inside panel. Further examples are sensors in the steering wheel, which can be used as sensors for switches in the steering wheel. Moreover, for example, a door heating element can be used as a capacitive sensor.

A third aspect of the invention relates to a method for controlling a function by means of a control system according to the invention comprising the following steps: operating a switch, in particular by way of a user, in particular by way of an occupant of a motor vehicle, such as a driver. Detecting at least one sensory signal of the switch by way of a detection unit of the control system and transmitting the sensory signal to a control unit of the control system. Initiating at least one function based on the at least one signal.

The invention also includes refinements of the control system according to the invention which comprise features as have been described in conjunction with the refinements of the motor vehicle according to the invention or the control system according to the invention. For this reason, the corresponding refinements of the according to the invention of the control system according to the invention are not described once again here.

The invention also comprises the combinations of the features of the described embodiments. The invention thus also comprises implementations which each comprise a combination of the features of several of the described embodiments, if the embodiments have not been described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

Exemplary embodiments of the invention are described hereinafter. In the figures:

FIG. 1 shows a schematic representation of a control system;

FIGS. 2a-2c show schematic representations of a switch of a control system;

FIGS. 3a-3b show schematic representations of a switch of a control system; and

FIG. 4 shows a schematic representation of a motor vehicle interior, which comprises a control system.

### DETAILED DESCRIPTION

Reference will now be made in detail to the preferred embodiments, examples of which are illustrated in the accompanying drawings, wherein like reference numerals refer to like elements throughout.

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also to comprise combinations of the features of the embodiments other than those shown. Furthermore, the described embodiments can also be supplemented with further features of the invention already described.

In the figures, identical reference signs each identify functionally-identical elements.

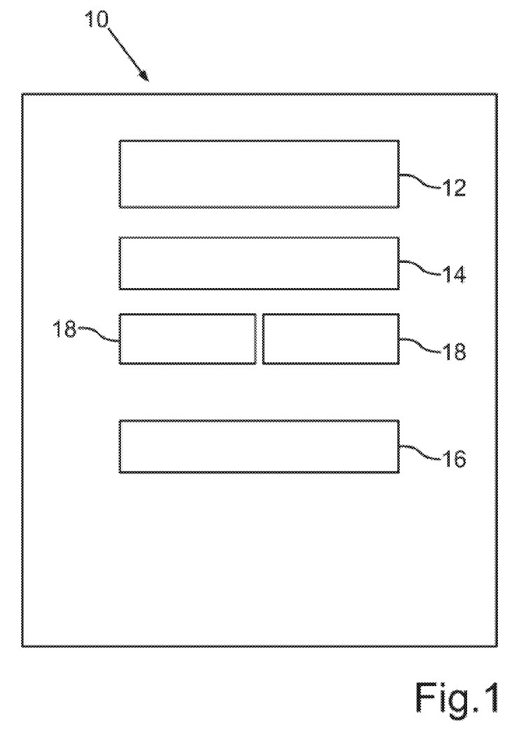

FIG. 1 shows a schematic representation of a control system 10. The control system 10 is used to control at least one function by means of at least one switch 12. The function can in particular comprise the operation of a motor vehicle component. The control system 10 furthermore comprises at least one switch 12. The switch 12 generates at least one sensory signal. The sensory signal is assigned to a predetermined state of the switch 12. One example of the predetermined state is “on” or “off”. The state can also be, for example, a rotational movement of the switch. The sensory signal is an acoustic signal or an optical signal or a combination of the two signals.

The control system 10 comprises at least one detection unit 14 configured to detect the at least one sensory signal of the at least one switch 12. The detection unit 14 generates a control signal.

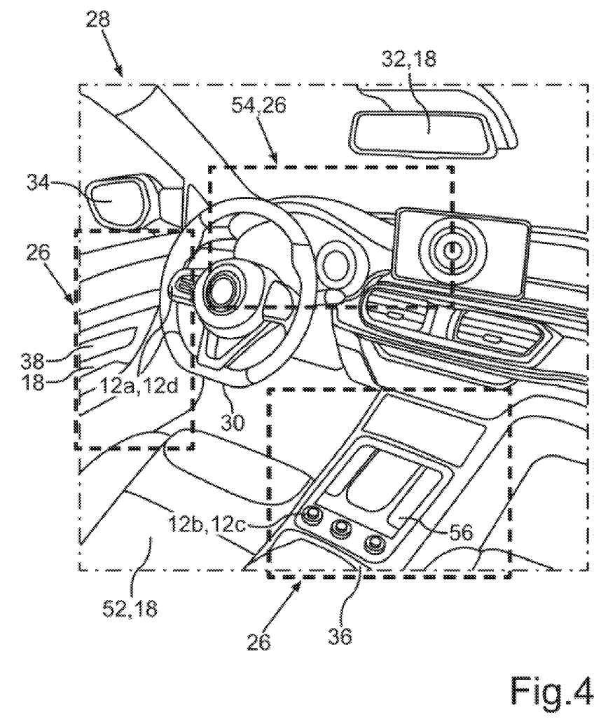

The control system 10 moreover comprises a control unit 16 configured to process the control signal generated by the detection unit 14. The control unit 16 is configured to initiate at least one predetermined function based on the control signal. For example, the control unit can adjust a seat of a motor vehicle (not shown) in a first direction. For example, the seat can be shifted to the rear away from the steering wheel 30 (shown in FIG. 4) of the motor vehicle or closer to the steering wheel 30 of the motor vehicle as an illustration.

The detection unit 14 comprises at least two detection elements 18 for recording the at least one sensory signal of the switch 12. The at least two detection elements 18 can be, for example, two acoustic detection elements 18. For example, there can be two microphones in a motor vehicle interior 18 (shown in FIG. 4). Additionally or alternatively, at least one detection element 18 of the two detection elements 18 can be an acoustic detection element 18, in particular a microphone, and at least one detection element 18 can be an optical detection element 18. One example of an optical detection element 18 can be a camera. For example, the optical detection element 18 can be an interior camera of a motor vehicle. Interior cameras are arranged, for example, in the rearview mirror 32 (shown in FIG. 4). The interior camera can record, for example, the position and/or the movement direction and/or the movement pattern of a hand of the driver. In this way, a structurally simple, precise identification of a sensory switch signature is possible. The control system 12 can thus reliably identify a respective switch 12 even if switch noises and/or interfering noises are superimposed and can therefore reliably carry out the respective predetermined function. The at least two detection elements 18 in other words permit a precise localization and assignment of a switch signal, such as a tone, which is generated upon operation of the switch 12. The at least two detection elements 18 have a predetermined distance to one another and to the switch 12 to be detected. The soundwaves of the acoustic signal reach the two detection elements 18, such as microphones, at different times depending on the position of the switch 12. The time difference between the signals of the two detection elements 18 is measured. The direction of the sound source can be calculated from the time-of-flight difference and the predetermined distance between the detection elements 18. Moreover, the level difference of the soundwaves can be determined. The direction and distance of the soundwaves can be identified precisely from the combination of the time-of-flight and the level differences, in particular with improved precision in comparison to the prior art. For the case that one detection element 18 is an optical detection element 18, for example, the movement of the switch 12 can be detected. The optical signal is not overlaid with acoustic interfering noises and in this way permits a precise identification of the moved switch 12. This precise identification of the switch 12 on the basis of its acoustic and/or optical switch signature permits more than one switch 12 to be able to be reliably controlled in this manner. This therefore permits a large number of switches 12 to be able to be operated without wiring in a motor vehicle, for example, and thus permits more sustainable equipment of motor vehicles in comparison to the present prior art.

Moreover, electronics costs and the associated installation space are saved by dispensing with the wires and contacts in the switch. Furthermore, there is the potential of producing the switch 12 only from plastic, which enables an improved recycling capability.

The detection unit 14 comprises at least one further detection element 18 for detecting sensory signals, in particular at least one capacitive sensor, a pressure sensor, a temperature sensor, and/or a light sensor and/or an acoustic sensor and/or an optical sensor.

The control unit 16 can additionally be configured to apply a functional logic, predefined parameter data, and/or further sensor data and/or user behavior data to control the at least one function.

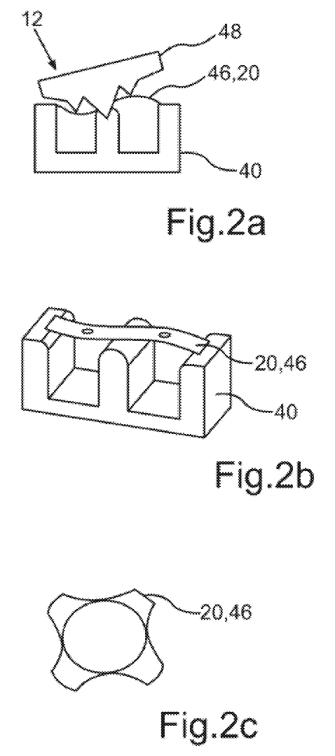

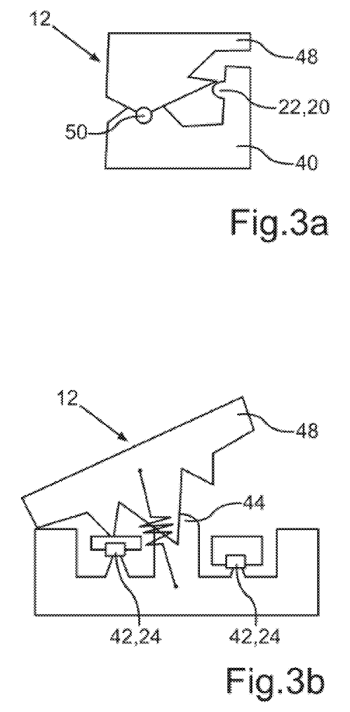

The switch 12 can be a mechanical switch, in particular a rocker switch, or a rotating switch or a turn-press switch or a toggle switch. The structure of such switches is shown by way of example in FIGS. 2a to 3b.

The switch 12 can in particular be a rotating switch 12b or turn-press switch 12c. In this case, the respective rotational direction of the rotating switch 12b, c can be assigned an acoustic and/or optical signal.

The predetermined function can advantageously be a comfort function. Additionally or alternatively, the initiation of the predetermined function can initiate a further function. For example, the outside mirrors 34 can be adjusted as a result of the adjustment of the seat position of a seat 52 in the motor vehicle. The comfort is enhanced still further for the user, for example, the driver, in this way. This has the additional advantage that a possible distraction from the road traffic is reduced still further.

The detection unit 14 can additionally be configured to detect user data. The detection unit 14 can additionally communicate with a neural network

FIG. 2a shows a schematic representation of a switch 12 of a control system 10. The switch 12 comprises at least one sound element 20 for generating the acoustic signal. The sound element 20 can be a mechanical sound element 20. The sound element 20 can be, for example, a clicker element 46. The sound element 20 is arranged here on a base 40 of the switch 12. The switch 12 furthermore comprises a switch element 48, by means of which the switch 12 is operated. The switch 12 can be a rocker switch 12a or a toggle switch 12d or a button 12e. In principle, the function of the switch 12 is that an individual sound is generated.

FIG. 2b and FIG. 2c show the sound element 20 constructed based on the clicker principle. The clicker principle relates to sound generation by using a spring 44 having two states, a stable state and a metastable state. In the stable state, the spring 44 is in its undeformed position. The spring 44 is neither stretched nor compressed and is in an energetically favorable state. If the spring 44 is bent by operating a rocker switch, for example, it jumps from the stable state to the metastable state. The metastable state is less stable and is only maintained by the force acting on the spring 44. As soon as the force decreases, the spring 44 returns to its stable state. The characteristic clicking noise is generated when the spring 44 jumps from one state to the other.

In other words, the switch 12 can generate at least one acoustic signal. The acoustic signal can be audible or inaudible to the human ear. The acoustic signal can be, for example, a sound or a tone. The acoustic signal can sound continuously or intermittently, for example, to accompany a movement. A suitable example is a click-clack, crack, or latching noise.

The switch 12 can generate at least one optical signal. The optical signal is a signal as a form of information transmission utilizing the physical properties of light. An optical signal is, for example, a change of the state of the switch 12 which can be detected by means of light signals. The optical signal can be illustratively explained on the basis of the example of a position change of a rocker switch 12a. The rocker switch 12a is located, for example, in a first state “on” or “off”. In this first state, the rocker switch is in a stable position, the position “on” or “off” is recognizable in a predetermined manner by the orientation of the rocker switch 12a. There is no movement. When the rocker switch 12a is operated, the lever or the rocker moves from the first position, for example, “off”, to the second position “on”. This movement can be optically perceived. The optical signal can change, for example, flashing or a color change can emphasize a movement. For example, an interior camera 18 arranged in a rearview mirror 32 of a motor vehicle can detect the left-right movement of a rotating switch 12b and the control unit 16 can generate the control signal therefrom, in that the volume is to be increased or decreased.

The switch 12 can generate at least one combined acoustic-optical signal. In other words, a combined acoustic-optical signal is a signal which comprises both acoustic and optical elements. In other words, this is a type of signal which uses both sound signals and light signals to transmit information. The combination results in a signal which is detectable both acoustically and optically. This is particularly advantageous with high noise levels, since the combination of acoustic and optical signal still permits a reliable identification. Rotating switches 12b, 12c can therefore also be replaced based on the combined acoustic-optical signal. For the case that at least two detection elements 18 are acoustic detection elements, a different tone preferably has to be generated in each rotational direction. For the case that at least one detection element is an optical detection element, in particular an interior camera, the rotational direction of the rotating switch 12b, 12c can be recognized via interior camera. For example, the number of the detents can be recognized by means of the clicking noise. Additionally or alternatively, the rotational angle can also be recognized by means of the interior camera.

FIG. 2c shows a clicker element 46 in the form of a clicker plate, for example, for a button 12e. The generated sound can be influenced in the layout via the design of the clicker element 46.

FIG. 3a shows a switch 12 having a sound element 20, wherein the sound element 20 comprises a snap over contour 22. The switch 12 shown in FIG. 3a is a very simply constructed switch, wherein the clicking noise is only generated in that an area of the switch 12 jumps over the snap over contour 22.

FIG. 3b shows a switch 12, in which the sound element 20 is mounted in a decoupled manner. The advantage results therefrom that interfering noises from the surroundings of the switch are damped. Examples of such interfering noises are structure-borne sound, and/or panel oscillations, for example, in a motor vehicle. It is conceivable that panel oscillations can inadvertently trigger a sensitively set switch. The sound precision is improved and inadvertent triggering of the switch is reduced or prevented by decoupling such interfering noises. In other words, the generated sound is tuned even more precisely by the decoupling. The switch 12 shown in FIG. 3b is in other words a spring-loaded switch 12 having two different sound elements 20.

The switch 12 can comprise at least one damping element 24 for decoupling the sound element 20. The damping element 24 can in particular comprise an elastomer or can be formed from an elastomer. The advantage results in this way that vibrations are damped particularly effectively. Elastomers absorb and insulate oscillations which would otherwise be transmitted to the sound element and thus prevent undesired resonances. The sound quality is improved in this way, the sound becomes clearer and more precise. Elastomers are long-lived and free of maintenance and maintain their damping properties over a long time.

The damping element permits it to be ensured precisely that after a sound, for example, a clicking noise, for example, a reverberation, thus an interfering noise, in particular an interfering frequency, is not detectable or is at least reduced.

FIG. 4 shows a motor vehicle interior 28, which comprises at least one control system 10. The motor vehicle comprises multiple switches 12. The switches 12 are assigned to predetermined zones 26 in the motor vehicle interior 28. At least one function, which is assigned to the predetermined zone 26, can be assigned in this case to the respective switch 12. The motor vehicle interior 28 shows an area of the cockpit of the motor vehicle which comprises a steering wheel 34, a dashboard 54, the rearview mirror 32, and an outside mirror 34. Furthermore, FIG. 4 shows a center console 36 having a functional island 56, an outside mirror 34, and a motor vehicle door interior panel 38. Detection elements 18 are in particular microphones and cameras which can be arranged, for example, in the rearview mirror 32.

The motor vehicle interior 28 shown can comprise a plurality of predetermined zones 26. For example, the center console 36, the steering wheel 30, and/or the dashboard 54 and/or the motor vehicle door interior panel 38 can form a respective zone 26. Further zones are, for example, the roof lining (not shown), a functional island 56 in the center console 36, and the seat 52.

Acoustic detection elements, in particular microphones, are often arranged in a motor vehicle, for example, in the roof lining, in the rearview mirror 32, in the dashboard 56, and/or in the A-pillar.

Optical detection elements, in particular cameras, in particular interior cameras, are often arranged in a motor vehicle, for example, in the rearview mirror, in the dashboard, in the roof lining, and/or in the A-pillar.

The control system 20 permits at least 5 to 20, in particular 10 to 15 acoustic signals per zone to be reliably identified in a structurally simple manner. The signals, in particular sounds or tones, can be the typical tones of the conventionally installed switches 12.

For example, the combination of an acoustic signal, in particular a sound, and an optical signal permits a signal profile which enables multiple equivalent switches 12 having the same sound to be identified particularly reliably due to the optically deviating profile in multiple positions in a predetermined zone 26.

Further sensors in a motor vehicle are, for example, seat heaters (not shown), which can be used, for example, as a capacitive sensor. For example, the position of a hand of the driver can be established. It can be established, for example, whether the hand is located next to the steering wheel 30 or in the area of the door interior panel 38. Further examples are sensors in the steering wheel 30, which can be used as sensors for switches 12 in the steering wheel. Moreover, a door heating element (not shown), for example, can be used as a capacitive sensor.

Functions, in particular of vehicle components, for example, of operating elements, comprise, for example: unlock locks, configure outside mirrors, operate lights in the roof lining, operate infotainment functions, such as set radio station, or volume control.

Functional logic and further parameters can be used in a motor vehicle in particular in combination with acoustic and/or optical detection elements. For example, the at least one detection unit 14 can analyze signals of cameras in combination with AI algorithms. In other words, visual data can be analyzed in consideration of further information and by means of predetermined AI algorithms to identify switches even more precisely. Further examples are speech commands and/or gesture recognition, these can be used in addition to the sensory signals for interpretation of the received signals. In this way, signal profiles can be defined even more exactly and moreover can learn the behavior of users, in particular occupants. Additionally or alternatively, a switch can be monitored in real time with the aid of machine learning.

The new concept comprises eliminating the wires at the switch 12. The goal is that the operation of the function, in particular of a motor vehicle component, is triggered via the individual sound of the switch 12, in other words the switch sound. This can possibly be assisted by further interior information. By eliminating wires and contacts in the switch 12, electronics costs and the associated installation space are saved. Furthermore, there is the potential of producing the switch only from plastic, which enables a recycling capability.

The identification or detection of the switch 12 and triggering of the function assigned to the switch 12 takes place, for example, in that an occupant has the desire to trigger a function, thus operate a motor vehicle component. For example, the occupant wishes to lower the window. The occupant operates the switch 12. This generates a sensory signal, for example, a special tone or sound, in particular a clicking noise. The clicking noise is now recognized via two detection elements 18, such as two interior microphones, and the function is carried out, thus the window is lowered. The interior microphones can be arranged, for example, in a door interior panel 38 and in the rearview mirror 32.

It is particularly advantageous to place more than two microphones in the motor vehicle interior 28, in order to also be able to determine the position of the noise even more precisely. The desired function can thus be ascertained even more unambiguously. Furthermore, the interior camera can also be evaluated as a detection element 18 in order to detect where the hands of the occupant who operates a switch are currently located, for example. This also restricts which switch 12 was operated.

The control system 10, in particular the detection unit 14, can particularly advantageously additionally infer the desired function by functional logic. If, for example, an operation is recognized in the area of the window lifter in a zone 26, for example, in the cockpit, and the window is closed in this zone 26, it can be inferred via the functional logic that lowering the window in the zone 26, thus in the cockpit, has been selected. For the overall processing of all sensory and further information, a neural network can advantageously be used.

The control system 10 having switches 12 can conceivably replace all existing switches 12 in a motor vehicle, wherein an accurate determination or also identification of the respective switch 12 is possible by means of the control system 10.

Overall, the examples show how a control using switch sound can be provided.

A description has been provided with particular reference to preferred embodiments thereof and examples, but it will be understood that variations and modifications can be effected within the spirit and scope of the claims which may include the phrase "at least one of A, B and C" as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A control system for controlling at least one function for operating a motor vehicle component, comprising:
at least one switch that generates at least one sensory signal which is assigned to a predetermined state of the at least one switch, the at least one sensory signal being an acoustic signal or an optical signal or a combination of the acoustic signal and the optical signal;
at least one detection unit configured to detect the at least one sensory signal of the at least one switch, the at least one detection unit generating a control signal; and
a control unit configured to process the control signal generated by the at least one detection unit, and the control unit being configured to initiate at least one predetermined function based on the control signal;
wherein the at least one detection unit comprises at least two detection elements for recording the at least one sensory signal of the at least one switch.

2. The control system according to claim 1, wherein the at least one switch comprises at least one sound element to generate the acoustic signal.

3. The control system according to claim 2, wherein the at least one sound element is a mechanical sound element.

4. The control system according to claim 2, wherein the at least one sound element comprises a snap over contour.

5. The control system according to claim 2, wherein the at least one sound element is mounted in a decoupled manner.

6. The control system according to claim 2, wherein the at least one switch comprises at least one damping element for decoupling the at least one sound element, and
the at least one damping element comprises an elastomer or is formed from an elastomer.

7. The control system according to claim 1, wherein
the at least two detection elements are acoustic detection elements, and/or
at least one detection element of the at least two detection elements is an acoustic detection element, and at least one detection element is an optical detection element.

8. The control system according to claim 1, wherein
the at least two detection elements are microphones, and/or
at least one detection element of the at least two detection elements is a microphone, and at least one detection element is a camera.

9. The control system according to claim 7, wherein the at least one detection unit comprises at least one further detection element for detecting sensory signals.

10. The control system according to claim 9, wherein the at least one further detection element is at least one capacitive sensor, a pressure sensor, a temperature sensor and/or a light sensor and/or an acoustic sensor and/or an optical sensor and/or an infrared sensor and/or a resistive sensor and/or an inductive sensor.

11. The control system according to claim 1, wherein the at least one detection unit is additionally configured to apply a functional logic, predefined parameter data, and/or further sensor data to control the at least one function.

12. The control system according to claim 1, wherein the at least one switch is a mechanical switch.

13. The control system according to claim 12, wherein the at least one switch is a rocker switch, or a rotating switch or a turn-press switch or a toggle switch, or a button.

14. The control system according to claim 12, wherein the at least one switch is a rotating switch or a turn-press switch and a respective rotational direction of the rotating switch is assigned the acoustic signal and/or the optical signal.

15. The control system according to claim 1, wherein the at least one predetermined function:
is a comfort function; and/or
initiation of the at least one predetermined function initiates a further function.

16. The control system according to claim 1, wherein
the at least one detection unit is configured to detect user data; and/or
the at least one detection unit communicates with a neural network.

17. A motor vehicle that comprises at least one control system according to claim 1.

18. The motor vehicle according to claim 17, wherein
the at least one switch is assigned to at least one predetermined zone in an interior of the motor vehicle; and/or
the at least one detection unit is assigned to the at least one predetermined zone in the interior of the motor vehicle; and/or
at least one function of at least one of predetermined zones of an operating element in the interior of the motor vehicle is assigned to the at least one switch.

19. A method for controlling a function of the control system according to claim 1, comprising:
operating the at least one switch;
detecting at least one sensory signal of the at least one switch by way of a detection unit of the control system and transmitting the at least one sensory signal to a control unit of the control system;
initiating at least one function based on the at least one sensory signal.
